(19) United States
(12) Patent Application Publication
(10) Pub. No.: US 2012/0280529 A1
(43) Pub. Date: Nov. 8, 2012

(54) COMPRESSION FORMED TRIM PANEL WITH AUDIO DEVICE

(75) Inventors: Ben Edward Sapak, West Olive, MI (US); Robert L. Hamelink, Hamilton, MI (US); Andy Ruiter, Holland, MI (US)

(73) Assignee: JOHNSON CONTROLS TECHNOLOGY COMPANY, Holland, MI (US)

(21) Appl. No.: 13/505,702

(22) PCT Filed: Nov. 11, 2010
(86) PCT No.: PCT/US10/56373

§ 371 Date: Jul. 30, 2012

Related U.S. Application Data
(60) Provisional application No. 61/260,247, filed on Nov. 11, 2009.

(51) Int. Cl. B60R 13/02

(52) U.S. Cl. 296/1.08

(57) ABSTRACT

A compression-formed trim panel for use in a vehicle. The trim panel includes a cover element, an attachment element, and a transducer audio output device. The attachment element includes a first end, an opposed second end, an inner surface, and an outer surface. The cover element includes a first end, an opposed second end, an inner surface, and an outer surface. The cover element is overlaid on the attachment element and secured thereto such that the cover element inner surface is adjacent the attachment element outer surface. The transducer audio output device is secured to the trim panel such that the trim panel acts as a sound board.

### CROSS REFERENCE TO RELATED APPLICATIONS

This application claims the benefit of and priority to U.S. Provisional Application No. 61/260,247, filed Nov. 11, 2009, which is incorporated herein by reference.

### BACKGROUND

The present disclosure relates generally to the field of vehicle trim panels and more particularly, to a trim panel including an audio device.

### DESCRIPTION OF THE RELATED ART

Trim panels are typically used in vehicles such as in the occupant compartment of a passenger vehicle. The trim panels provide a cover and finished interior over the metal parts such as the frame (which is referred to as the body in white, or BIW) of the vehicle. For example, garnish trim panels are used to cover the A, B, C and/or D pillars that extend between the vehicle's body and its roof. Conventionally, the garnish trim panels are formed by injection molding a plastic material. In less expensive vehicles, the show or A-surface of the injection-molded garnish trim panel is painted and/or provided with a grain pattern. In more expensive vehicles, the show or A-surface is formed by providing a fabric covering on the injection-molded garnish trim panel. The injection-molded portion of the garnish trim panel provides the desired stiffness and rigidity to the garnish trim panel. It also serves as an attachment structure that enables the garnish trim panel to be attached to the underlying metal pillar; an energy-absorbing structure for impact protection; and provides a location where acoustic materials can be added to reduce sound from entering the occupant compartment from the vehicle body.

It is also generally known to provide an audio system within the interior of a vehicle. The audio system may typically include an AM/FM radio, satellite radio tuner, a TV tuner, a compact disc (CD) player, digital media player, a cassette tape player, or other type of input to the audio system. The audio system may also include a speaker installed in the interior, such as in the front dash, center console, door panel, or rear compartment of the vehicle. Controls for the audio system are typically located in the front dash, center console and on a steering wheel of the vehicle.

Known injection-molding garnish trim panels have a number of disadvantages. For example, because they are typically formed of plastic material that is rigid at room temperature, buzz-squeak-rattle (BSR) noise can occur when vibration or contact occurs between the metal pillar and the rigid injection-molded garnish trim panel. To prevent this BSR noise, the injection-molded garnish trim panel may be tightly connected to the vehicle's pillar. In addition, a layer of material, such as felt, may be attached to the injection-molded garnish trim panel at locations where BSR noise may occur.

Known trim panels that include audio output devices also diminish or degrade the quality of the audio signals emanating from the audio output devices located within the trim panel. These known audio systems also occupy a substantial amount of interior space in various regions of the vehicle such as door panels, consoles, dash panels, and the like.

Accordingly, there is a need to provide a compression formed trim panel that is adaptable, enhances the sound quality of the audio system, and is less expensive to manufacture and install.

### SUMMARY

Accordingly, the present disclosure relates to a compression-formed trim panel for use in a vehicle. The compression-formed trim panel includes a cover element, an attachment element, and a transducer audio output device. The trim panel includes a cover element, an attachment element, and an audio device. The attachment element includes a first end, an opposed second end, an inner surface, and an outer surface. The cover element includes a first end, an opposed second end, an inner surface, and an outer surface. The cover element is overlaid on the attachment element and secured thereto such that the cover element inner surface is adjacent the attachment element outer surface. The transducer audio output device is secured to the trim panel such that the trim panel acts as a sound board.

An advantage of the present disclosure is that the trim panel can be adapted to house audio output devices but not diminish or degrade the quality of the audio signal emanating from the audio output device located within the trim panel. Another advantage of the present disclosure is that the trim panel is lightweight, less expensive to manufacture and install, and improves performance and quality of the audio system. A further advantage of the present disclosure is that the trim panel occupies less space thereby increasing vehicle interior space and reducing installation and production costs. A further advantage of the present disclosure is that the trim panel enables the use of full frequency output creating a better sound quality, sound stage, and image.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle having an interior trim panel, according to an exemplary embodiment.

FIG. 2 is a side view of an A-pillar garnish trim panel including an audio output device, according to an exemplary embodiment.

FIG. 3 is a perspective view of a vehicle interior, including a garnish trim panel attached to the vehicle's A-pillar, according to an exemplary embodiment.

FIG. 4 is a perspective view of a vehicle interior, including a garnish trim panel attached to the vehicle's C-pillar, according to an exemplary embodiment.

FIG. 5 is a perspective view of a vehicle interior, including a garnish trim panel attached to the center panel of the vehicle, according to an exemplary embodiment.

FIG. 6 is a perspective view of a transducer audio output device, according to an exemplary embodiment.

### DESCRIPTION

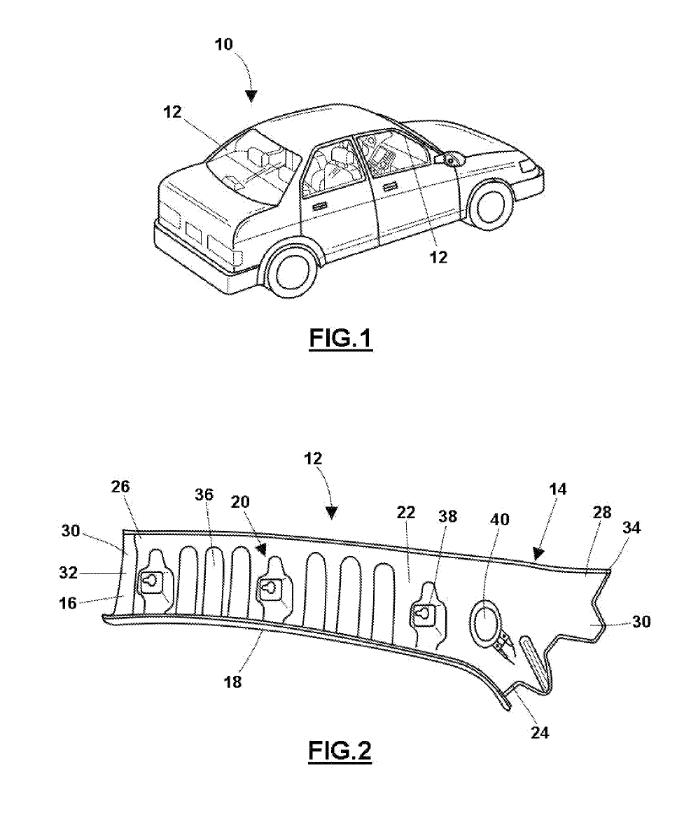

Referring to FIG. 1, a vehicle 10 having a plurality of compression formed garnish trim panels 12 according an exemplary embodiment is shown. While the vehicle 10 shown is a 4-door sedan, it should be understood that the innovation of the present disclosure may be used in a mini-van, sport utility vehicle or any other means in or by which someone travels or something is carried or conveyed for any market or application including everything from transportation to planes and space travel and everything in between.

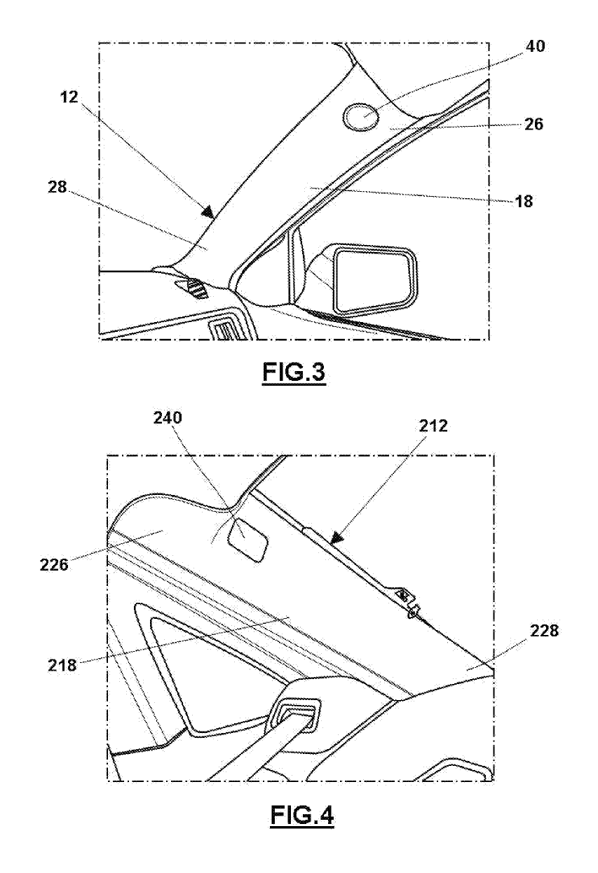

Referring to FIGS. 2 and 3, a compression formed garnish trim panel 12 is shown. The trim panel 12 includes a cover element 14 that is generally planar and has an inner surface (B-Surface) 16 and an outer surface (A-Surface) 18. The cover element outer surface 18 preferably provides an aesthetically pleasing visible surface, or show or A-surface for the trim panel 12. The cover element may be covered in a variety of predetermined materials, such as, fabric, leather, pleather, to further enhance visual appeal and acoustics. The trim panel 12 may include one or more structures for attachment to a vehicle. The structures may be tabs, extensions, or the like. In this example, the trim panel 12 is designed for the A-pillar, and the upper portion 26 and lower portion 28 of the cover element 14 includes a plurality of tabs 30 that secure the trim panel 12 to other components, such as, the instrument panel, interior roof, vehicle space frame, or the like. The cover element 14 may also include a lower flared portion 32 that may rest against the instrument panel to provide a finished appearance and an upper flared portion 34 that may rest against the vehicle interior roof.

The trim panel 12 also includes an attachment element 20 that severs various functions. For example, the trim panel may facilitate attachment to the vehicle, create a structure for the compression formed component(s) of the trim panel 12, act as an energy absorbing structure during impacts, and constrain the audio device to the vehicle pillar trim. The attachment element inner surface 22 may have a plurality of structures or features, such as, corrugations, ridges, projections, ribs, extensions, curvatures, holes, depressions, or the like, for attachment, rigidity, strength, acoustical enhancement, or the like. In this example, the attachment element inner surface 22 includes a plurality of horizontal corrugations 36 extending away from the inner surface 22 that span a portion of the trim panel 12 from its lower end 26 to its upper end 28. The attachment element inner surface 22 may also include a plurality of holes 38 that may be used to attach the trim panel 12 to the vehicle 10, such as, the A-Pillar of the vehicle's space frame, or the like.

The trim panel 12 may also have a predetermined profile and contours that correspond with the vehicle frame contours to which the trim panel 12 is to be attached. In this example, the trim panel 12 has a U-shaped profile and contours corresponding to the vehicle's A-Pillar to which trim panel 12 is attached, as shown in FIG. 3.

The garnish trim panel 12 also includes an audio device 40, such as, a transducer audio output device, speaker, or the like. The transducer 40 is integrated with the trim panel 12 such that the transducer 40 creates sound pressure off the surface of the trim panel (“sound board”), thereby creating audio output. The transducer 40 is positioned and secured to the attachment element inner surface 22 using fasteners, screws, adhesives, or the like. The transducer may also be placed within trim panel 12 hole fitted to receive and house the transducer 40. The transducer is positioned at a predetermined location and preferably at a location that optimizes audio quality, such as the upper end of the trim panel 12 such that the transducer 40 or other audio device is near an occupant's ears. The cover element 14 and/or attachment element 20 may also include a hole 38 for at least partially disposing the transducer 40 therein. In this example, the transducer 40 is positioned at the trim panel upper portion 26 such that it will be closer in the vicinity of an occupant's ears thereby enhancing audio performance for the occupant(s). It is noted that the audio device may also include other types of devices, such as, a microphone, an antenna, or the like. The transducer 40 and audio system can also be operatively connected to various technologies, such as, digital signal processing technology, or the like, to further optimize the audio output from the transducer 40.

The cover element 14 and/or the attachment element 20 can be formed by compression-forming a compression-formable thermoplastic or thermosetting substrate using various techniques. It is also contemplated that any suitable material, such as, polypropylene, polypropylene glass matt (fiberglass reinforced polypropylene), polypropylene and natural fiber (polypropylene reinforced with natural fibers), glass matt reinforced thermoplastic, polymer, reinforced polymer composite material, foam core made from an elastomer and binders or binding agents, polyurethane, or the like, may be compression formed to produce the trim panel 12 or a portion of the trim panel 12, such as, the cover element 14, attachment element 20. In other embodiments, the compression-formed garnish trim panel 12 may be made from a substrate that does not diminish or degrade the quality of the audio signals emanating from the audio output device installed behind the compression formed garnish trim panel 12.

Alternatively, the cover element 14 and attachment element 20 may be formed as two separate components wherein the attachment element 20 serves as a backside carrier having an inner surface 22 and an outer surface 24. The cover element inner surface 16 is overlaid onto the attachment element outer surface 24 and secured thereto to form a generally elongated planar trim panel 12 having a lower end 26 and an opposed upper end 28. The cover element 14 can be secured to the attachment element 20 using adhesives, fasteners, snap-fitting, clamps, or the like.

Referring now to FIG. 4, a vehicle interior, including a compression-formed garnish trim panel 212 according to another embodiment is shown wherein like features are represented by like reference numbers increased by 200. In this embodiment, a compression-formed garnish trim panel 212 is designed and contoured to attach to the vehicle's C-pillar.

Referring now to FIG. 5, a vehicle interior, including a compression-formed garnish trim panel 312 according to another embodiment is shown wherein like features are represented by like reference numbers increased by 300. In this embodiment, a compression-formed garnish trim panel 312 is designed and contoured to attach to the center panel (used for the center audio channel) of the vehicle.

According to other embodiments, the center panel can be designed such that the top surface of the center panel and instrument panel are flush. The compression formed trim panels can be designed for use in a variety of areas within the vehicle 10, such as, pillar areas (e.g., A-pillar, B-pillar, C-pillar, D-pillar, etc.), front and/or rear dash panel areas, center panels, door panels, console panels, instrument panels, or the like.

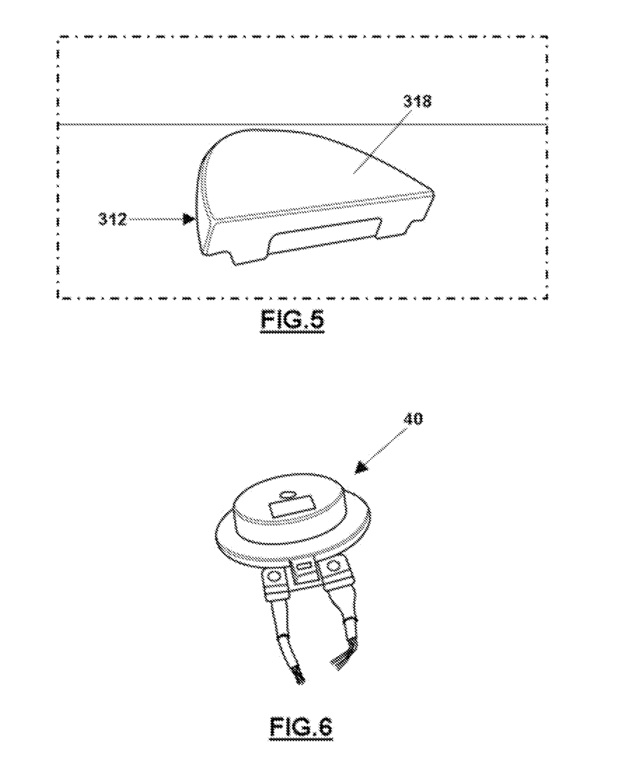

Referring now to FIG. 6, a transducer audio output device 40 is shown. The transducer audio output device (e.g., speaker, etc.) 40 converts electrical signals into a variable magnetic field and, subsequently, into acoustic waves to produce an audio output. The transducer 40 has a relatively or sufficiently small size such that it may be inserted/attached/positioned behind and/or to the compression-formed garnish trim panel 12 and occupy a minimal amount of space. For example, in one exemplary embodiment, the transducer audio output device 40 is attached to the inner surface of the compression-formed garnish trim panel 12, as shown in FIG. 2.

Alternatively, the attachment element 20 may be formed as a separate component that serves as a backside carrier. The attachment element 20 having an inner surface 22 and an outer surface 24. The cover element inner surface 16 is overlaid onto the attachment element outer surface 24 and secured thereto to form a generally elongated planar trim panel 12 having a lower end 26 and an opposed upper end 28, as shown in FIG. 3. The cover element 14 can be secured to the attachment element 20 using a variety of predetermined techniques, such as, using adhesives, fasteners, snap-fitting, clamps, or the like.

Many modifications and variations of the present disclosure are possible in light of the above teachings. Therefore, within the scope of the appended claim, the present disclosure may be practiced other than as specifically described.

What is claimed is:

1. A compression-formed trim panel for use in a vehicle, the trim panel comprising:
an attachment element having a first end, an opposed second end, an inner surface, and an outer surface;
a cover element having a first end, an opposed second end, an inner surface, and an outer surface, wherein the cover element is overlaid on the attachment element and secured thereto such that the cover element inner surface is adjacent the attachment element outer surface; and
a transducer audio output device secured to the trim panel such that the trim panel acts as a sound board.

2. The compression-formed trim panel of claim 1, wherein attachment element includes a plurality of corrugations spanning at least a portion of the attachment element for enhancing trim panel strength and audio output quality.

3. The compression-formed trim panel of claim 1, wherein the attachment element includes a plurality of holes for attachment of the trim panel to the vehicle.

4. The compression-formed trim panel of claim 1, wherein the trim panel includes a plurality of tabs extending outwardly from an upper and lower end of the trim panel.

5. The compression-formed trim panel of claim 1, wherein the trim panel has a profile corresponding to the profile of a portion of the vehicle.

6. The compression-formed trim panel of claim 1, wherein the trim panel includes a flared portion at an upper end of the trim panel and at a lower end of the trim panel for enhancing the visual appearance of the trim panel.

7. The compression-formed trim panel of claim 1, wherein the trim panel is coupled to an A-pillar of the vehicle.

8. A compression-formed trim panel for use in a vehicle, the trim panel comprising:
an attachment element having a first end, an opposed second end, an inner surface, and an outer surface, wherein the attachment element inner surface includes a plurality of corrugations spanning at least a portion of the attachment element inner surface;
a cover element having a first end, an opposed second end, an inner surface, and an outer surface, wherein the cover element is overlaid on the attachment element and secured thereto such that the cover element inner surface is adjacent the attachment element outer surface; and
a transducer audio output device secured to the attachment element inner surface such that the trim panel acts as a sound board, wherein the transducer is coupled to an audio system having digital signal processing technology that optimizes the output of the audio system.

9. The compression-formed trim panel of claim 8, wherein attachment element includes a plurality of corrugations spanning at least a portion of the attachment element for enhancing trim panel strength and audio output quality.

10. The compression-formed trim panel of claim 8, wherein the attachment element includes a plurality of holes for attachment of the trim panel to the vehicle.

11. The compression-formed trim panel of claim 8, wherein the trim panel includes a plurality of tabs extending outwardly from an upper and lower end of the trim panel for enhancing the visual appearance of the trim panel.

12. The compression-formed trim panel of claim 8, wherein the trim panel has a profile corresponding to the profile of a portion of the vehicle.

13. The compression-formed trim panel of claim 8, wherein the trim panel includes a flared portion at an upper end of the trim panel and at a lower end of the trim panel.

14. The compression-formed trim panel of claim 8, wherein the trim panel is coupled to an A-pillar of the vehicle.

15. A compression-formed trim panel for use in a vehicle, the trim panel comprising:
an outer surface;
an inner surface having a plurality of structures for coupling to a space frame pillar of the vehicle; and
a transducer audio output device secured to the inner surface such that the trim panel acts as a sound board.
